(19) United States
(12) Patent Application Publication
(10) Pub. No.: US 2022/0175184 A1
(43) Pub. Date: Jun. 9, 2022

(54) PROCESSING APPARATUS, PROCESSING METHOD, AND NON-TRANSITORY STORAGE MEDIUM

(71) Applicant: NEC Corporation, Minato-ku, Tokyo (JP)

(72) Inventor: Eisuke SANEYOSHI, Tokyo (JP)

(73) Assignee: NEC Corporation, Minato-ku, Tokyo (JP)

(21) Appl. No.: 17/617,410

(22) PCT Filed: Jun. 13, 2019
(86) PCT No.: PCT/JP2019/023506

§ 371 Date: Dec. 8, 2021

(51) Int. Cl. A47J 36/32; A47J 27/00; G06Q 20/20

(52) U.S. Cl. CPC A47J 36/32; G06Q 20/202; A47J 27/004

(57) ABSTRACT

The present invention provides a processing apparatus (10) including an acquisition unit (11) that acquires energy consumption information indicating current consumption or power consumption of an electric cooker, a cooking status estimation unit (12) that estimates, based on the energy consumption information, the number of products cooked by use of the electric cooker, and a sale preparation status estimation unit (13) that estimates, based on a result of the estimation by the cooking state estimation unit (12), the number of the products that is cooked and in a state of being ready for sale.

### TECHNICAL FIELD

The present invention relates to a processing apparatus, a processing method, and a program.

### BACKGROUND ART

A store such as a convenience store or a supermarket provides a service of cooking, at the store, and selling a product such as a croquette or a fried chicken. In the service, since a wait time is generated by cooking after an order is received, it is a general practice to previously cook, and preserve and exhibit a cooked matter in a warmer or the like. Hereinafter, a product provided by the service is called a “cooking product”.

Patent Document 1 discloses a system that analyzes running status of process equipment, based on power information of the process equipment, and notifies in such a way as to put a material into the process equipment, based on an analysis result. Note that, running status that can be determined is “cooking or not”, “additionally cooking or not”, or “warming or not”, and recognition of a detailed cooking content and achieving means thereof are not disclosed.

Patent Document 2 discloses a cooking equipment management apparatus including a memory that stores cooking pattern information indicating a change between a standby temperature and a cooking temperature of cooking equipment according to a food, and a control unit that performs temperature control of the cooking equipment, based on cooking pattern information read from the memory, when receiving order information indicating an ordered food from a terminal apparatus. The memory stores the cooking pattern information in which a switch start timing from the standby temperature to the cooking temperature is determined in such a way that a temperature setting of the cooking equipment is switched from the standby temperature to the cooking temperature, and then switched to the standby temperature with an elapse of a cooking time as a condition, and that a cooking end time of each foodstuff coincides in a food including a plurality of kinds of foodstuffs differing in cooking condition.

### RELATED DOCUMENT

### Patent Document

[Patent Document 1] Japanese Patent Application Publication No. 2014-178910

[Patent Document 2] Japanese Patent Application Publication No. 2011-177073

### DISCLOSURE OF INVENTION

### Technical Problem

In order to reduce a problem such as a sale opportunity loss or a discard loss of a cooking product, it is desired to recognize what number of cooking products are in a state of being ready for sale (a state of being already cooked, and preserved in a warmer or the like) at each timing. In order to recognize this, “information indicating sale and discard timing and the number” indicated by point of sales (POS) data is not sufficient, and “information indicating a timing of cooking a cooking product and the number thereof” is also needed. Patent Document 1 discloses an acquisition means for “information indicating a timing of cooking a cooking product”, but neither describes nor suggests a desire for “information indicating the number of cooked products” and an acquisition means thereof. Patent Document 2 neither describes nor suggests a desire for “information indicating a timing of cooking a cooking product and the number thereof” and an acquisition means thereof.

An object of the present invention is to provide a means for acquiring information indicating a timing of cooking a cooking product and the number thereof.

### Solution to Problem

The present invention provides a processing apparatus including:

an acquisition means for acquiring energy consumption information indicating current consumption or power consumption of an electric cooker;

a cooking status estimation means for estimating, based on the energy consumption information, the number of products cooked by use of the electric cooker; and

a sale preparation status estimation means for estimating, based on a result of estimation by the cooking state estimation means, the number of first products being the product that is cooked and in a state of being ready for sale.

Moreover, the present invention provides a processing method including:

by a computer,

acquiring energy consumption information indicating current consumption or power consumption of an electric cooker;

estimating, based on the energy consumption information, the number of products cooked by use of the electric cooker; and

estimating, based on an estimation result of the number of the product cooked by use of the electric cooker, the number of first products being the product that is cooked and in a state of being ready for sale.

Moreover, the present invention provides a program that causes a computer to function as:

an acquisition means for acquiring energy consumption information indicating current consumption or power consumption of an electric cooker;

a cooking status estimation means for estimating, based on the energy consumption information, the number of products cooked by use of the electric cooker; and

a sale preparation status estimation means for estimating, based on a result of estimation by the cooking state estimation means, the number of first products being the product that is cooked and in a state of being ready for sale.

### Advantageous Effects of Invention

The present invention achieves a means for acquiring information indicating a timing of cooking a cooking product and the number thereof.

### BRIEF DESCRIPTION OF THE DRAWINGS

The above-described object, other objects, features, and advantages effects will become more apparent from a preferred example embodiment described below and the following accompanying drawings.

FIG. 1 is a diagram illustrating an outline of a processing apparatus according to the present example embodiment.

FIG. 2 is a diagram illustrating one example of a hardware configuration of the processing apparatus according to the present example embodiment.

FIG. 3 is one example of a functional block diagram of the processing apparatus according to the present example embodiment.

FIG. 4 is one example of a functional block diagram of a sensor according to the present example embodiment.

FIG. 5 is a diagram schematically illustrating one example of information processed by the processing apparatus according to the present example embodiment.

FIG. 6 is a diagram schematically illustrating one example of information processed by the processing apparatus according to the present example embodiment.

FIG. 7 is a flowchart illustrating one example of a flow of processing in the processing apparatus according to the present example embodiment.

FIG. 8 is a flowchart illustrating one example of a flow of processing in the processing apparatus according to the present example embodiment.

### EXAMPLE EMBODIMENT

First, an outline of a processing apparatus according to the present example embodiment is described. The processing apparatus is utilized at a store such as a convenience store or a supermarket, more specifically, a store that provides a service of cooking, at the store, and selling a cooking product such as a croquette or a fried chicken. Note that, in the service, a cooking product is previously cooked, and is preserved and exhibited in a warmer or the like.

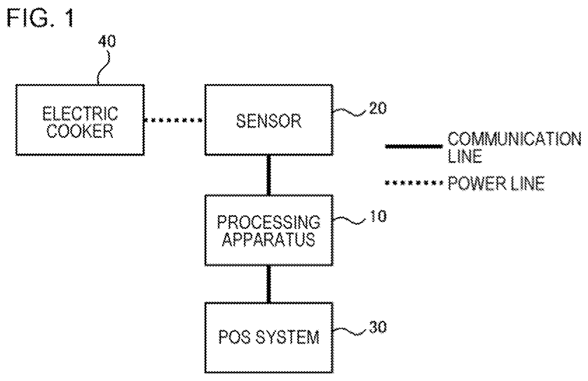

As illustrated in a functional block diagram in FIG. 1, a processing apparatus 10 is communicable with a sensor 20 and a POS system 30.

The processing apparatus 10 acquires, from the sensor 20, energy consumption information indicating current consumption or power consumption of an electric cooker 40 utilized in cooking of a cooking product. Then, the processing apparatus 10 estimates, based on the energy consumption information, the number and cooking timings of products cooked by use of the electric cooker 40. Moreover, the processing apparatus 10 acquires, from the POS system 30 of a store, a sale and discard record indicating the number and a timing of sale and discard of cooking products. Then, the processing apparatus 10 estimates, based on a result of the estimation and the sale and discard record, the number of cooking products that is cooked and in a state of being ready for sale at each timing.

Such processing apparatus 10 can accurately estimate the number of cooking products that is cooked and in a state of being ready for sale at each timing. A problem such as a sale opportunity loss or a discard loss of a cooking product can be reduced by determining, based on an estimation result, an appropriate timing of performing cooking of a cooking product, and outputting a guidance encouraging cooking at the timing.

A configuration of the processing apparatus 10 according to the present example embodiment is described in detail below. First, one example of a hardware configuration of the processing apparatus 10 is described. Each functional unit included in the processing apparatus 10 is achieved by any combination of hardware and software, including a central processing unit (CPU) of any computer, a memory, a program loaded on the memory, a storage unit (that can store not only a program previously stored from a phase of shipping an apparatus, but also a program downloaded from a storage medium such as a compact disc (CD), a server on the Internet, and the like) such as a hard disk storing the program, and an interface for network connection. Then, it is appreciated by a person skilled in the art that there are a variety of modification examples of methods and apparatuses for the achievement.

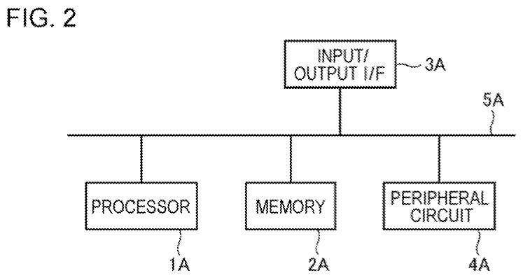

FIG. 2 is a block diagram illustrating a hardware configuration of the processing apparatus 10. As illustrated in FIG. 2, the processing apparatus 10 includes a processor 1A, a memory 2A, an input/output interface 3A, a peripheral circuit 4A, and a bus 5A. The peripheral circuit 4A includes various modules. The processing apparatus 10 may not include the peripheral circuit 4A. Note that, the processing apparatus 10 may be configured by a plurality of physically and/or logically separated apparatuses, or may be configured by one physically and/or logically integrated apparatus. When the processing apparatus 10 is configured by a plurality of physically and/or logically separated apparatuses, each of the plurality of apparatuses can include the hardware configuration described above.

The bus 5A is a data transmission path for the processor 1A, the memory 2A, the peripheral circuit 4A, and the input/output interface 3A to mutually transmit and receive data. The processor 1A is, for example, an arithmetic processing apparatus such as a CPU and a graphics processing unit (GPU). The memory 2A is a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can give an instruction to each of modules, and perform an arithmetic operation, based on an arithmetic result of each of the modules.

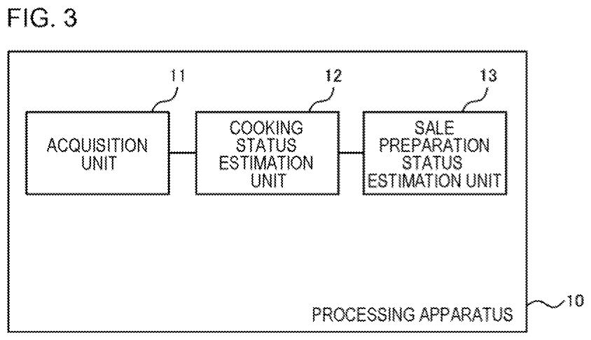

Next, a functional configuration of the processing apparatus 10 is described in detail. FIG. 3 illustrates one example of a functional block diagram of the processing apparatus 10. As illustrated, the processing apparatus 10 includes an acquisition unit 11, a cooking status estimation unit 12, and a sale preparation status estimation unit 13.

The acquisition unit 11 acquires, from the sensor 20, energy consumption information indicating current consumption or power consumption of the electric cooker 40. Moreover, the acquisition unit 11 acquires, from the POS system 30, a sale and discard record of cooking products.

The electric cooker 40 is electric equipment utilized for cooking of a cooking product. For example, an electric fryer, an electric steamer, an electric heater, or the like is exemplified as the electric cooker 40, but the present invention is not limited thereto.

Energy consumption information may be an instantaneous value of current consumption [A] or power consumption [W], may be an integrated value, an average value, or the like for a certain time, may be time-series data (waveform data) of current consumption or power consumption, or may be a root mean square (RMS) value (effective value). Energy consumption information includes information indicating a measurement date and time of each measurement value.

The sensor 20 is placed in a power supply unit of the electric cooker 40, performs sensing at the position, and acquires energy consumption information. The power supply unit is a distribution board, a power strip, a power cable, a power outlet, or the like, but is not limited thereto.

For example, the electric cooker 40 is connected to any of branch wires (power feed wires) on a distribution board. The sensor 20 measures current or the like in the branch wire on the distribution board, and transmits the measured current to the processing apparatus 10 via a communication interface incorporated in the sensor 20.

The sensor 20 may be a current transformer (CT) type current sensor that converts measured current into secondary current according to a winding ratio, a Hall element type current sensor that converts a magnetic field generated around measured current into voltage by utilizing a Hall effect, or the like. Power consumption can be computed from current consumption and a voltage value.

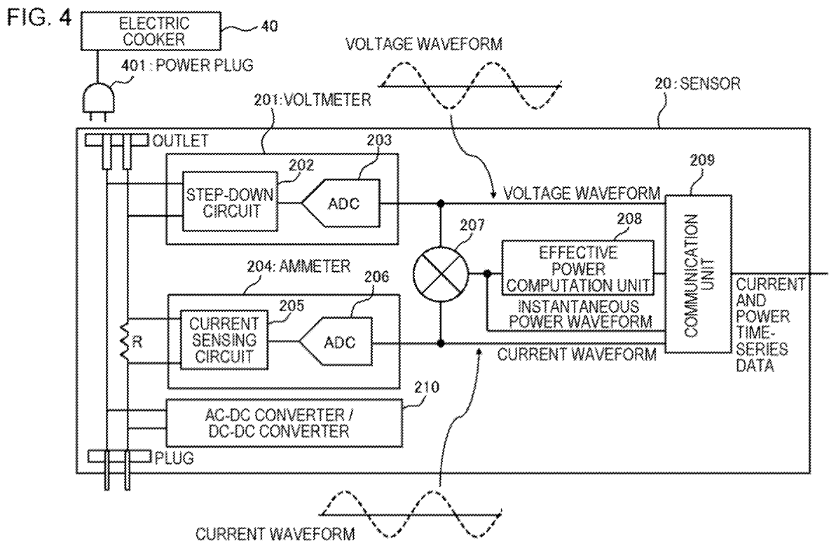

FIG. 4 is a diagram illustrating one example of the sensor 20 that measures power of the power supply unit of the electric cooker 40. In a case of this example, the power supply unit of the electric cooker 40 is a power strip. With reference to FIG. 4, the sensor 20 includes a voltmeter 201 that measures inter-terminal voltage of a power outlet, and an ammeter 204 that measures current. The voltmeter 201 includes a step-down circuit 202 that steps down inter-terminal voltage, and an analog-digital converter 203 that converts analog output voltage of the step-down circuit 202 into a digital signal. The ammeter 204 includes a current sensing circuit 205 that senses current flowing in a power line (load), and an analog-digital converter 206 that converts analog output voltage of the current sensing circuit 205 into a digital signal. Voltage waveform data from the analog-digital converter 203 of the voltmeter 201 and power waveform data from the analog-digital converter 206 of the ammeter 204 are multiplied in, for example, a multiplier 207, and an instantaneous power waveform is acquired. The instantaneous power waveform is smoothed by an effective power computation unit 208, and an effective power value is computed. The voltage waveform data, the power waveform data, the instantaneous power waveform, and the effective power value are input to a communication unit 209. The communication unit 209 transmits time-series data (waveform data) of current or time-series data (waveform data) of a power value to the processing apparatus 10. In this instance, the communication unit 209 may transmit time-series data (waveform data) of a current value and/or time-series data (waveform data) of a power value, when receiving a measurement command from the processing apparatus 10. In FIG. 4, an alternate current (AC)-direct current (DC) converter/DC-DC converter 210 generates direct current (DC) power from alternate current (AC) power, and supply the DC power to the analog-digital converters 203 and 206, the multiplier 207, the effective power computation unit 208, and the communication unit 209. Note that, although single-phase two-wire system alternate current is illustrated in FIG. 4, measurement can be performed by use of, for example, three single-phase power meters in a case of three-phase three-wire system alternate current as well. Alternatively, measurement based on a two-wattmeter method may be performed regarding power.

The sensor 20 may constantly perform acquisition of energy consumption information and transmission thereof to the processing apparatus 10, or may perform acquisition of energy consumption information and transmission thereof to the processing apparatus 10, for only a partial predetermined time period with a predetermined event as a trigger.

The predetermined event is detection of cooking start of a cooking product using the electric cooker 40. For example, when cooking of a cooking product using the electric cooker 40 is started, a clerk of a store performs input of this fact to any apparatus. Any apparatus is, for example, any of a plurality of apparatuses placed inside a store, and connected to an intra-store communication network. For example, a POS system, a register, a store server, a store terminal, or the like is exemplified as an apparatus placed inside a store and connected to an intra-store communication network, but the present invention is not limited thereto. When a clerk of a store performs input of start of cooking a cooking product to any apparatus, information indicating this fact is transmitted from any apparatus to the sensor 20 via an intra-store communication network. The sensor 20 starts acquisition of energy consumption information and transmission thereof to the processing apparatus 10 in response to the input, and, after continuing for a predetermined certain time, ends the processing. Note that, although the sensor 20 and any apparatus perform transmission and reception of information via the intra-store communication network herein, the sensor 20 and any apparatus may directly perform transmission and reception of information by any wired and/or wireless communication means.

Moreover, although it is assumed, in the example described above, that processing is ended after elapse of a certain time from start of the processing, a clerk of a store may input end of cooking of a cooking product to any apparatus, as a modification example. Then, the information may be transmitted from any apparatus to the sensor 20. The sensor 20 may end acquisition of energy consumption information and transmission thereof to the processing apparatus 10 in response to the input of the end.

As another example, the electric cooker 40 may be connected to an intra-store communication network. In a case of this example, when the electric cooker 40 accepts a predetermined operation of starting cooking, information indicating this fact is transmitted from the electric cooker 40 to the sensor 20 via the intra-store communication network. The sensor 20 starts acquisition of energy consumption information and transmission thereof to the processing apparatus 10 in response to the operation, and, after continuing for a predetermined certain time, ends the processing. Note that, although the sensor 20 and the electric cooker 40 perform transmission and reception of information via the intra-store communication network herein, the sensor 20 and the electric cooker 40 may directly perform transmission and reception of information by any wired and/or wireless communication means.

Moreover, although it is assumed, in the example described above, that processing is ended after elapse of a certain time from start of the processing, the electric cooker 40 may transmit, in response to end of cooking of a cooking product, this fact to the sensor 20, as a modification example. Then, the sensor 20 may end acquisition of energy consumption information and transmission thereof to the processing apparatus 10 in response to notification of the end.

The sensor 20 may perform measurement, and transmission of energy consumption information to the processing apparatus 10 every certain time, for example, at a time interval (sampling interval) within a cooking time (ex: a croquette “30 seconds”).

Moreover, the sensor 20 may transmit energy consumption information acquired by measurement to the processing apparatus 10 by real-time processing, or may transmit the energy consumption information to the processing apparatus 10 by batch processing every predetermined time (ex: every 1 minute, every 5 minutes, or every 10 minutes).

A sale and discard record indicates the number of pieces of sale, a sale timing (date and time), the number of discards, and a discard timing (date and time), for each product. Note that, the acquisition unit 11 may acquire only a sale and discard record relating to a cooking product, or may acquire a sale and discard record relating to another product in addition to a cooking product.

The acquisition unit 11 may acquire a sale and discard record by batch processing every predetermined time (ex: every 1 minute, every 5 minutes, or every 10 minutes). In addition, when a piece of new data is registered in a sale and discard record, the POS system 30 may transmit the sale and discard record to the processing apparatus 10 each time. In addition, when a piece of new data relating to a cooking product is registered in a sale and discard record, the POS system 30 may transmit the sale and discard record to the processing apparatus 10 each time.

Note that, in the present description, “acquisition” may include “fetching, by a local apparatus, data stored in another apparatus or a storage medium (active acquisition)”, for example, receiving by requesting or inquiring of the another apparatus, accessing the another apparatus or the storage medium and reading, and the like, based on a user input, or based on an instruction of a program. Moreover, “acquisition” may include “inputting, into a local apparatus, data output from another apparatus (passive acquisition)”, for example, receiving data given by distribution (or transmission, push notification, or the like), based on a user input, or based on an instruction of a program. Moreover, “acquisition” may include selecting and acquiring from received data or information, and “generating new data by editing of data (conversion into text, rearrangement of data, extraction of partial data, alteration of a file format, or the like) or the like, and acquiring the new data”.

The cooking status estimation unit 12 estimates, based on the energy consumption information acquired by the acquisition unit 11, the number of cooking products cooked by use of the electric cooker 40. The cooking status estimation unit 12 achieves the estimation, based on any of a plurality of estimation methods described below. Note that, a kind of a cooked cooking product can also be estimated by the estimation method.

Carrying out cooking using the electric cooker 40 involves consumption of power for running the electric cooker 40. Then, as the number of cooking products to be cooked increases, necessary heat energy increases, and current consumption or power consumption increases. Moreover, current consumption or power consumption can differ depending on a kind of a cooking product to be cooked. Further, a time-series change of current consumption or power consumption can differ depending on the number of cooking products to be cooked. Also, a time-series change of current consumption or power consumption can differ depending on a kind of a cooking product to be cooked.

As a first estimation method, for example, the cooking status estimation unit 12 may estimate the number of cooking products cooked by use of the electric cooker 40, based on a comparison result between a “numerical value range previously set for each number of cooking products” and a “statistical value (ex: an average value, a maximum value, a minimum value, a mode, a median, or the like) of an instantaneous value of current consumption or power consumption indicated by energy consumption information, or an instantaneous value for a predetermined most recent time”. A numerical value range indicates a standard of current or power consumed by the electric cooker 40 when each number of cooking products is cooked. Note that, the numerical value range may be determined based on an actual measurement value, acquired by a preliminary experiment or the like, of current or power consumed by the electric cooker 40 when each number of cooking products is cooked.

Moreover, since current consumption or power consumption can change due to deterioration of the electric cooker 40 with time or the like, the numerical value range may be suitably corrected. For example, the numerical value range may be corrected based on energy consumption information acquired by the acquisition unit 11 and an estimation result by the cooking status estimation unit 12. As one example, a numerical value range where a statistical value (ex: an average value, a maximum value, a minimum value, a mode, a median, or the like) of energy consumption information for a predetermined most recent number of times at which the cooking status estimation unit 12 determines “M cooking products are being cooked” becomes a median may be computed as a numerical value range set in response to M cooking products.

As a second estimation method, for example, the cooking status estimation unit 12 may estimate the number of cooking products cooked by use of the electric cooker 40, based on a collation result between a pattern of a time-series change of current consumption or power consumption previously set for each number of cooking products, and a pattern of a time-series change of current consumption or power consumption indicated by energy consumption information.

For collation of a pattern, pattern matching, machine learning, processing of computing a correlation value between a measured pattern and a pattern to be collated, and using a pattern with a minimum correlation value, or the like can be utilized. A cross-correlation value can be utilized as a computation method of a correlation value, and, in this case, a correlation value r can be computed as below with energy consumption information being x[i] (i=1, . . . , N), and a power pattern to be collated being y[i]. Note that, an x-bar is an average value of x's, and a y-bar is an average value of y's.

$$\begin{matrix}[ Mathematical 1 ] & \\ r = \frac{\frac{1}{N} {\sum }_{i = 1}^{N} ( x [ i ] - \overline{x} ) ( y [ i ] - \overline{y} )}{\sqrt{\frac{1}{N} {\sum }_{i = 1}^{N} {( x [ i ] - \overline{x} )}^{2}} \sqrt{\frac{1}{N} {\sum }_{i = 1}^{N} {( y [ i ] - \overline{y} )}^{2}}} & Equation ( 1 )\end{matrix}$$

As a third estimation method, for example, the cooking status estimation unit 12 may estimate a kind and the number of cooking products cooked by use of the electric cooker 40, by use of an estimation model of estimating a kind and the number of a cooked cooking products from energy consumption information (an instantaneous value or time-series data), and the energy consumption information. The estimation model is generated by machine learning based on learning data associating a kind and the number of cooked cooking products, with energy consumption information measured during cooking of each number of various cooking products or a feature value thereof. The feature value may be, for example, a frequency intensity and phase (harmonic component) of current consumption or power consumption, a phase, a change of current consumption, an average value, a peak value, an effective value, a crest factor, a form factor, a convergence time of a current change, a conducting time, a position of a peak, a time difference between a peak position of voltage and a peak position of current consumption, a power factor, a component of a specific frequency (½ cycle, ⅓ cycle, or the like), or a change amount of each of these feature values, or may be another feature value.

The sale preparation status estimation unit 13 estimates, based on an estimation result by the cooking status estimation unit 12, and a sale and discard history of a cooking product acquired by the acquisition unit 11 from the POS system 30, the number of cooking products (hereinafter, “first cooking products”) that is cooked, is not sold or discarded yet, and is in a state of being ready for sale.

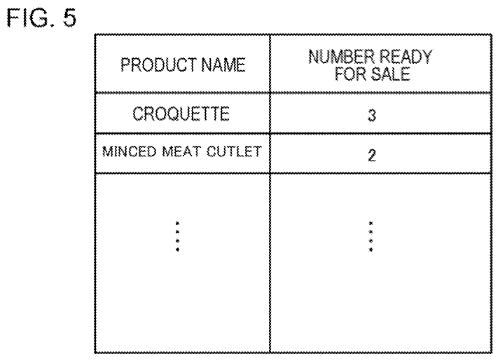

For example, as illustrated in FIG. 5, the sale preparation status estimation unit 13 can estimate the number of the first cooking products at a current point. The number of the first cooking products at a current point can be derived by subtracting “the number of cooking products sold or discarded up to a current point” indicated by a sale and discard history of a cooking product, from “the number of cooking products cooked up to a current point” indicated by an estimation result by the cooking status estimation unit 12.

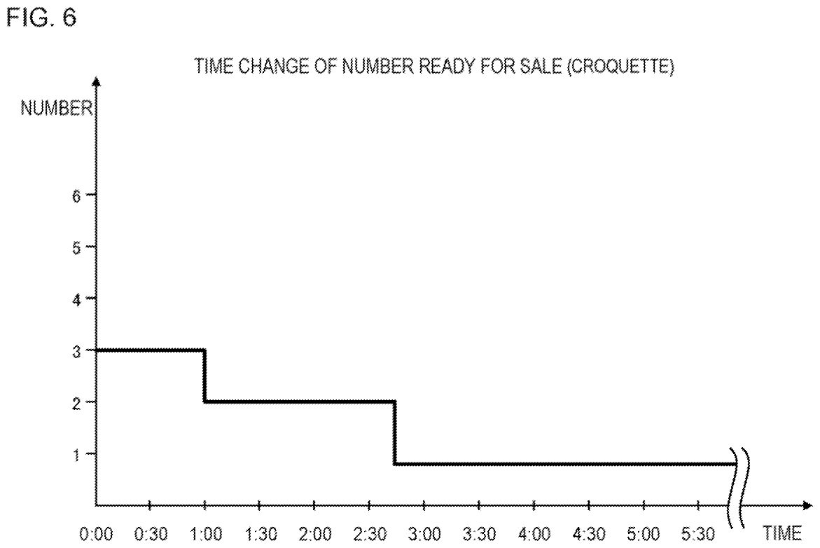

In addition, as illustrated in FIG. 6, the sale preparation status estimation unit 13 may estimate a time-series change of the number of the first cooking products. A time-series change of the number of the first cooking products is computed by computing the number of the first cooking products at each of a plurality of timings by use of a method of computing the number of the first cooking products at a current point.

Note that, the processing apparatus 10 may compare a criterion value with the number of the first cooking products at a current point, and, when the number of the first cooking products at a current point becomes equal to or less than the criterion value, output a guidance encouraging cooking of the first cooking product. Alternatively, the processing apparatus 10 may compare a criterion time with a continuation time of a state in which the number of the first cooking products at a current point is equal to or less than the criterion value, and, when the continuation time of the state exceeds the criterion time, output a guidance encouraging cooking of the first cooking product.

The processing apparatus 10 previously holds information indicating a criterion value and a criterion time, and performs the comparison processing described above by utilizing the information. Note that, at least either one of a criterion value and a criterion time stored in the processing apparatus 10 may differ for each cooking product. Moreover, at least either one of a criterion value and a criterion time stored in the processing apparatus 10 may differ for each time period or day of a week.

An output of a guidance encouraging cooking may be achieved via an output apparatus included in any apparatus (ex: a POS system, a register, a store server, a store terminal, or the like) connected to the intra-store communication network, or an output apparatus connected to the any apparatus above. A display, a projection apparatus, a printer, a speaker, a caution lamp, or the like is exemplified as the output apparatus, but the present invention is not limited thereto. In addition, a transmission destination e-mail address for the guidance may be previously registered in the processing apparatus 10. Then, the processing apparatus 10 may transmit the guidance to the registered transmission destination e-mail address.

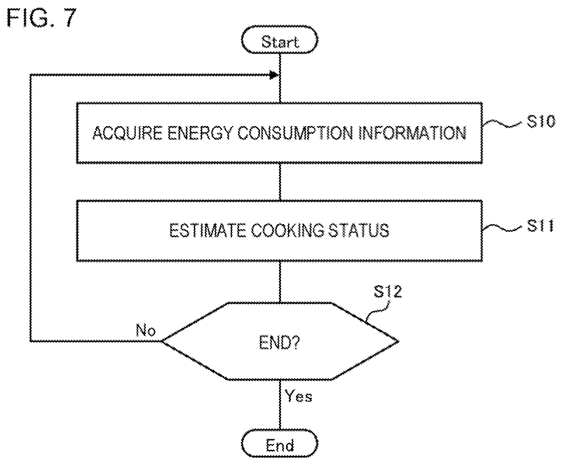

Next, one example of a flow of processing in the processing apparatus 10 is described by use of a flowchart in FIG. 7.

First, when the acquisition unit 11 of the processing apparatus 10 acquires energy consumption information from the sensor 20 (S10), the cooking status estimation unit 12 estimates the number of cooking products cooked by use of the electric cooker 40, based on the energy consumption information acquired in S10 (S11). Thereafter, the processing apparatus 10 repeats the processing until there is an input of ending the processing.

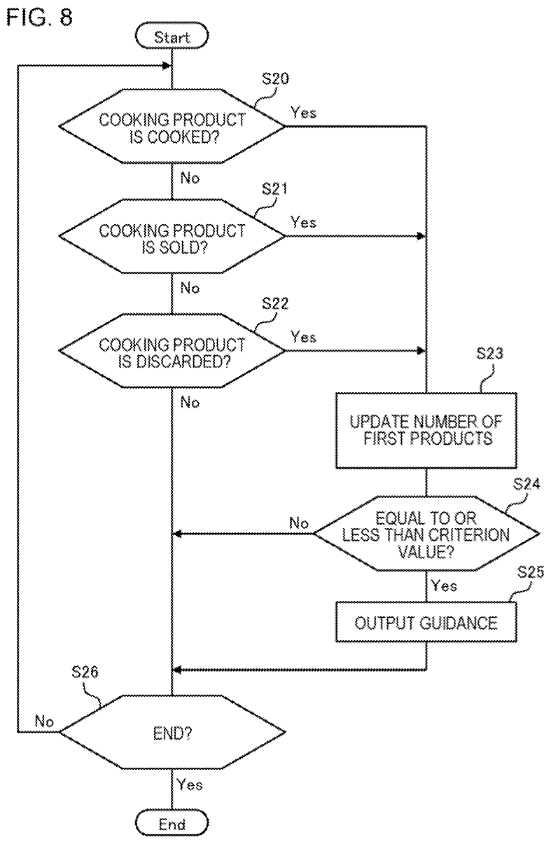

Next, one example of a flow of processing in the processing apparatus 10 is described by use of a flowchart in FIG. 8.

The processing apparatus 10 continues acquisition of an estimation result of the number of cooking products cooked by use of the electric cooker 40, and acquisition of a sale and discard record of a cooking product transmitted from the POS system 30.

Then, when any of the estimation result and sale and discard record described above is acquired, the sale preparation status estimation unit 13 determines whether a cooking product is newly cooked, based on the acquired estimation result and sale and discard record described above (S20). When determining that a cooking product is newly cooked (Yes in S20), the sale preparation status estimation unit 13 updates the number (see FIG. 5) of cooking products (first cooking products) that is cooked, is not sold or discarded yet, and is in a state of being ready for sale at a current point (S23). Specifically, the number of newly cooked cooking products is added as many as the newly cooked cooking products.

Then, the processing apparatus 10 compares the number after the update with a criterion value (S24). When the number of the first cooking products at a current point is equal to or less than the criterion value (Yes in S24), the processing apparatus 10 outputs a guidance encouraging cooking of the first cooking product (S25).

On the other hand, when not determining that a cooking product is newly cooked (No in S20), the sale preparation status estimation unit 13 determines whether a cooking product is newly sold (S21). When determining that a cooking product is newly sold (Yes in S21), the sale preparation status estimation unit 13 updates the number (see FIG. 5) of cooking products (first cooking products) that is cooked, is not sold or discarded yet, and is in a state of being ready for sale at a current point (S23). Specifically, the number of newly sold cooking products is subtracted as many as the newly sold cooking products.

Then, the processing apparatus 10 compares the number after the update with the criterion value (S24). When the number of the first cooking products at a current point is equal to or less than the criterion value (Yes in S24), the processing apparatus 10 outputs a guidance encouraging cooking of the first cooking product (S25).

On the other hand, when not determining that a cooking product is newly sold (No in S21), the sale preparation status estimation unit 13 determines whether a cooking product is newly discarded (S22). When determining that a cooking product is newly discarded (Yes in S22), the sale preparation status estimation unit 13 updates the number (see FIG. 5) of cooking products (first cooking products) that is cooked, is not sold or discarded yet, and is in a state of being ready for sale at a current point (S23). Specifically, the number of newly discarded cooking products is subtracted as many as the newly discarded cooking products.

Then, the processing apparatus 10 compares the number after the update with the criterion value (S24). When the number of the first cooking products at a current point is equal to or less than the criterion value (Yes in S24), the processing apparatus 10 outputs a guidance encouraging cooking of the first cooking product (S25).

Note that, an order of determinations in S20, S21, and S22 is not limited to an illustrated order.

According to the processing apparatus 10 described above, a cooking product cooked by the electric cooker 40, the number thereof, and the like, can be estimated based on energy consumption information relating to the electric cooker 40. Then, the processing apparatus 10 can accurately estimate, based on the estimation result and a sale and discard history acquired from a POS system, the number of cooking products that is cooked and in a state of being ready for sale at each timing.

Moreover, according to the processing apparatus 10, the estimation by a comparatively simple hardware alteration being placement of the sensor 20 can be achieved. Thus, a hurdle of introduction becomes low.

Further, according to the processing apparatus 10, based on the estimation result, an appropriate timing of performing cooking of a cooking product can be determined, and a guidance encouraging cooking can be output at the timing. As a result, a problem such as a sale opportunity loss or a discard loss of a cooking product can be reduced.

Moreover, according to the processing apparatus 10, a criterion value and a criterion time utilized in order to determine a timing of outputting a guidance encouraging cooking can differ for each cooking product, each time period, each day of a week, or the like. Since a guidance encouraging cooking can be output based on an appropriate criterion (a criterion value or a criterion time) at each timing, a problem such as a sale opportunity loss or a discard loss of a cooking product can be further reduced.

Further, since a time-series change of the number of cooking products that is cooked and in a state of being ready for sale can be computed, various analyses become possible, such as an analysis of a relation between a tendency of the change and sale. As a result, an optimum sale strategy can be developed.

While the invention of the present application has been described above with reference to the example embodiment (and example), the invention of the present application is not be limited to the example embodiment (and example) described above. Various alterations that a person skilled in the art is able to understand can be made to a configuration and details of the invention of the present application, within the scope of the invention of the present application.

Some or all of the above-described example embodiments can also be described as, but not limited to, the following supplementary notes.

1. A processing apparatus including:

an acquisition means for acquiring energy consumption information indicating current consumption or power consumption of an electric cooker;

a cooking status estimation means for estimating, based on the energy consumption information, the number of products cooked by use of the electric cooker; and

a sale preparation status estimation means for estimating, based on a result of estimation by the cooking state estimation means, the number of first products being the product that is cooked and in a state of being ready for sale.

2. The processing apparatus according to supplementary note 1, wherein

the acquisition means
acquires a sale and discard record of the product from a POS system, and the sale preparation status estimation means
estimates, based on an estimation result by the cooking status estimation means,
   and the sale and discard record, the number of the first products being the product that is cooked, is not sold or discarded yet, and is in a state of being ready for sale.
   3. The processing apparatus according to supplementary note 1 or 2, wherein

the sale preparation status estimation means estimates the number of the first products at a current point.

4. The processing apparatus according to any one of supplementary notes 1 to 3, wherein

the sale preparation status estimation means estimates a time-series change of the number of the first products.

5. The processing apparatus according to any one of supplementary notes 1 to 4, wherein

the cooking status estimation means estimates the number of the first products by computing a statistical value of the energy consumption information, and comparing the statistical value with a numerical value range according to cooking status.

6. The processing apparatus according to any one of supplementary notes 1 to 4, wherein

the cooking status estimation means estimates the number of the first products by pattern matching based on the energy consumption information.

7. The processing apparatus according to any one of supplementary notes 1 to 4, wherein

the cooking status estimation means estimates the number of the first products by computing a correlation value between the energy information and the energy information according to cooking status.

8. A processing method including:

by a computer,

acquiring energy consumption information indicating current consumption or power consumption of an electric cooker;

estimating, based on the energy consumption information, the number of products cooked by use of the electric cooker; and

estimating, based on an estimation result of the number of the products cooked by use of the electric cooker, the number of first products being the product that is cooked and in a state of being ready for sale.

9. A program that causes a computer to function as:

an acquisition means for acquiring energy consumption information indicating current consumption or power consumption of an electric cooker;

a cooking status estimation means for estimating, based on the energy consumption information, the number of products cooked by use of the electric cooker; and

a sale preparation status estimation means for estimating, based on a result of estimation by the cooking state estimation means, the number of first products being the product that is cooked and in a state of being ready for sale.

What is claimed is:

1. A processing apparatus comprising:
at least one memory configured to store one or more instructions; and
at least one processor configured to execute the one or more instructions to:
acquire energy consumption information indicating current consumption or power consumption of an electric cooker;
estimate, based on the energy consumption information, a number of products cooked by use of the electric cooker; and
estimate, based on a result of estimation by the cooking state estimation means, a number of first products being the product that is cooked and in a state of being ready for sale.

2. The processing apparatus according to claim 1, wherein the processor is further configured to execute the one or more instructions to:
acquire a sale and discard record of the product from a point of sales (POS) system, and
estimate, based on an estimation result by the cooking status estimation means, and the sale and discard record, the number of the first products being the product that is cooked, is not sold or discarded yet, and is in a state of being ready for sale.

3. The processing apparatus according to claim 1
wherein the processor is further configured to execute the one or more instructions to estimate the number of the first products at a current point.

4. The processing apparatus according to claim 1,
wherein the processor is further configured to execute the one or more instructions to estimate a time-series change of the number of the first products.

5. The processing apparatus according to claim 1,
wherein the processor is further configured to execute the one or more instructions to estimate the number of the first product by computing a statistical value of the energy consumption information, and comparing the statistical value with a numerical value range according to cooking status.

6. The processing apparatus according to claim 1,
wherein the processor is further configured to execute the one or more instructions to estimate the number of the first products by pattern matching based on the energy consumption information.

7. The processing apparatus according to claim 1, wherein the processor is further configured to execute the one or more instructions to estimate the number of the first products by computing a correlation value between the energy consumption information and the energy consumption information according to cooking status.

8. A processing method comprising:
by a computer,
acquiring energy consumption information indicating current consumption or power consumption of an electric cooker;
estimating, based on the energy consumption information, a number of products cooked by use of the electric cooker; and
estimating, based on an estimation result of the number of the products cooked by use of the electric cooker, a number of first products being the product that is cooked and in a state of being ready for sale.

9. A non-transitory storage medium storing a program that causes a computer to:
acquire energy consumption information indicating current consumption or power consumption of an electric cooker;
estimate, based on the energy consumption information, a number of products cooked by use of the electric cooker; and
estimate, based on a result of estimation by the cooking state estimation means, a number of first products being the product that is cooked and in a state of being ready for sale.
